(19) United States
(12) Patent Application Publication
(10) Pub. No.: US 2006/0252466 A1
(43) Pub. Date: Nov. 9, 2006

(54) Mechanism for using a laptop in an automobile

(76) Inventor: Gene P. Isabell JR., Fort Worth, TX (US)

Correspondence Address: STORM LLP, BANK OF AMERICA PLAZA, 901 MAIN STREET, SUITE 7100, DALLAS, TX, 75202, US

(21) Appl. No.: 11/258,260

(22) Filed: Oct. 25, 2005

Related U.S. Application Data
(60) Provisional application No. 60/677,954, filed on May 5, 2005.

(51) Int. Cl. H04M 1/00

(52) U.S. Cl. 455/569.2

(57) ABSTRACT

An apparatus and system are provided to allow for increased flexibility in the use of portable computers in conjunction with automobiles. By having a coupling device within an automobile that allows a portable computer to access a plurality of internal features as well as perform additional functions, the system allows passengers to better and more fully utilize otherwise wasted time in transit. Hence, the overall utility of automobiles and portable computers can be increased versus any other commercially available system.

### CLAIM OF PRIORITY

This application claims priority to U.S. Provisional Patent Application No. 60/677,954, entitled “MECHANISM FOR USING A LAPTOP IN AN AUTOMOBILE,” filed on behalf of inventor Gene Isabell, which is hereby incorporated by reference for all purposes.

### TECHNICAL FIELD

The invention relates generally to mobile computing and, more particularly, to use of laptop or portable computers in automobiles.

### BACKGROUND

The advent of more compact and powerful computing systems has resulted in increased usage in applications relating to automobiles. For example, Digital Versatile Disc (DVD) players coupled to foldable Liquid Crystal Displays (LCDs) have become more ubiquitous in automobiles. Remote satellite communication systems, such as XM® Radio, and satellite television installations in automobiles have also become more popular. Global Positioning Systems (GPS) have also become increasingly and widely used in automobiles for emergency situations, navigation and so forth.

Typically, though, these features are integrated into the automobile. Devices like the DVD players are built into the automobiles themselves. Either custom manufacturing or custom installation is required, and if a change is desired, then it can become costly to make any substantive changes.

In addition, there is a steadily increasing number of additional devices that can be added individually, with the advent of satellite radio and specialized audio systems, which are commercially available. In such cases, enthusiasts would have to purchase devices piecemeal.

To date, there has not been a unified, multipurpose device that could be integrated into an automobile. Mostly, the introduction of such a multipurpose device having increased versatility has been hampered by price. However, with the lower cost and increased computing power, the demand for such versatile devices has increased.

Therefore, there is a need for a method and/or apparatus for integrating a more flexible computing system into an automobile that addresses at least some of the problems associated with conventional systems. Additionally, the ability to utilize a computing system in both the automobile and as a separate stand-alone unit apart from the automobile provides greater flexibility and cost-justification for such a system.

### SUMMARY OF THE INVENTION

The present invention, accordingly, provides a system comprising an automobile having at least one auxiliary hardware module with at least one intended function and having a coupler adapted to communicate with the hardware module. A portable computer is also included that is adapted to be removably secured to the coupler so as to provide processing and software to the hardware module to enable the hardware to perform the intended function, the portable computer being fully functional whether secured to the coupler or not.

In another preferred embodiment of the present invention, the hardware module further comprises a satellite radio antenna and audio equipment. Also, in yet another preferred embodiment of the present invention, the portable computer processes a signal received by the satellite radio antenna and outputs audio data to the audio equipment.

In another preferred embodiment of the present invention, the hardware module further comprises a Digital Versatile Disc (DVD) player and audio equipment. Also, in yet another preferred embodiment of the present invention, the portable computer processes a signal from the DVD player, outputs video, and outputs audio data to the audio equipment.

In another preferred embodiment of the present invention, the hardware module is Radio Frequency (RF) equipment. In another preferred embodiment of the present invention, the RF equipment is a Global Positioning System (GPS) antenna, and another preferred embodiment of the present invention comprises the portable computer processing a signal from the GPS antenna and outputs indicia of GPS data. In another preferred embodiment of the present invention, the RF equipment is selected from the group consisting of Wireless Fidelity (WiFi), cellular, and Code Division Multiple Access (CDMA) equipment, and another preferred embodiment of the present invention includes the portable computer that provides wireless Internet Access.

In an alternative embodiment of the present invention, an apparatus is provided for coupling a portable computer to an automobile. The apparatus includes a mounting bracket for removably securing the portable computer. Also included is at least one communication channel adapted to interconnect the portable computer to at least one auxiliary hardware module with at least one intended function.

In another embodiment of the present invention, an apparatus for coupling a portable computer to an automobile is provided. The apparatus comprises a mounting bracket for mechanically connecting and supporting the portable computer, and at least one interface unit that is at least configured to interconnect the portable computer to at least one on-board automobile feature. Specifically, though, by means of the interface unit, the portable computer can be used to perform a variety of functions, or can be coupled to a variety of on-board automobile equipment that performs the functions, including, but not limited to, wireless network communications equipment (such as WiFi and other wireless means of connecting to the Internet or another computer network), a GPS antenna, satellite communication systems (such as OnStar®, satellite radio and satellite television), Liquid Crystal Displays (LCDs), DVD players, and audio equipment. This will enable passengers to access the Internet, check e-mail, download audio and video files, play audio and video files, and request traffic or other information. Additionally, the portable computer can be used as a stand-alone device when removed from the coupling apparatus or with another docking mechanism in a different location, such as at a person's home or office.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of an automobile and computer system integration embodying features of the present invention;

FIG. 2 is a block diagram depicting an integration system embodying a preferred embodiment of the present invention; and

FIG. 3 is a block diagram depicting a system which is another embodiment of the present invention.

### DETAILED DESCRIPTION

In the following discussion, numerous specific details are set forth to provide a thorough understanding of the present invention. In other instances, well-known elements have been illustrated in schematic or block diagram form in order not to obscure the present invention in unnecessary detail.

It is further noted that, unless indicated otherwise, all functions described herein are performed by a processor such as a computer or electronic data processor in accordance with code such as computer program code, software, or integrated circuits that are coded to perform such functions.

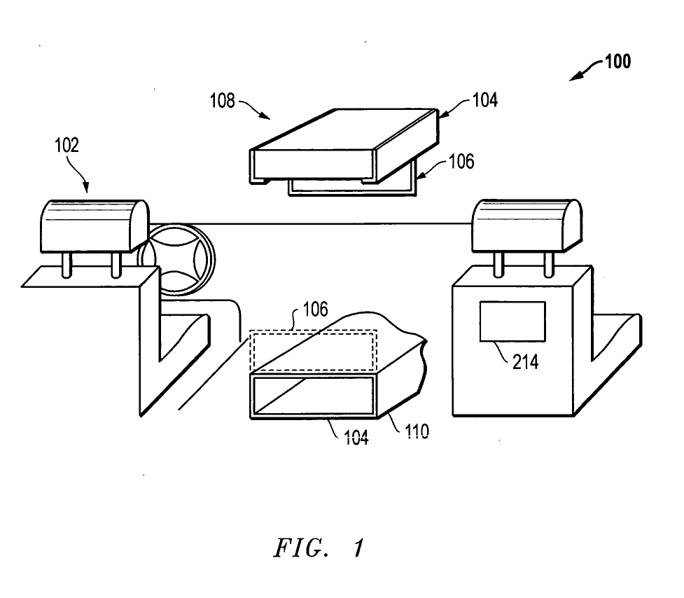

Referring to FIG. 1 of the drawings, the reference numeral 100 generally designates an automobile and computer system integration embodying features of the present invention. The system 100 comprises an automobile 102, a coupling device 104, and a portable computer 106.

Within the passenger compartment of the automobile 102, the coupling device 104 is accessible to passengers. In one embodiment, the coupling device 104 is mounted to the interior roof or ceiling 108 of the automobile 102, and the display of the portable computer 106 opens downward so it can be viewed by at least one passenger in the automobile 102. In another arrangement of the present invention, the coupling device 104 is mounted in an opening in the console 110 between the front seats of the automobile 102, and the portable computer 106 is inserted in the coupling device 104 such that the display extends above the top of the console 110 so that it can be viewed by at least one passenger in the automobile 102. Note that it is possible to mount the coupling device 104 to any fixture within the passenger compartment, such as a center panel, seat back, dashboard, and so forth. Also in another embodiment, the coupling device 104 can be mounted in a trunk or other auxiliary compartment.

A portable computer 106 is then inserted into the coupling device 104. Typically, laptop computers are utilized as portable computers 106; however, in other embodiments, it is possible to employ tablet computers, or other portable computer systems. It can be appreciated that devices such as portable computers 106 can be operated separately from the coupling device 104, or in conjunction with other docking stations or coupling devices in other locations. Thus, a single portable computer 106 could be used in a home, office, and vehicular setting, reducing the need to have multiple computers in different geographic locations.

Once the portable computer 106 is coupled to the automobile 102 by means of the coupling device 104, a variety of functions can be performed. Typically, portable computers 106 have large memory storage areas and have general purpose applicability. For example, portable computers 106 can play music and/or videos, perform word processing functions, and so forth. All of these functions can be performed while the portable computer 106 is coupled to the automobile 102 via the coupling device 104.

In one arrangement of the present invention, the coupling device 104 also contains one or more information storage devices, such as a hard drive, compact disk drive, flash card drive, or DVD drive, that can be used in conjunction with the portable computer 106. It can be appreciated that some of the portable computers 106 can also contain one or more of these drives.

In another arrangement of the present invention, the coupling device 104 also incorporates one or more security devices (not shown) for retaining the portable computer 106 in the coupling device 104. The security devices can be mechanical, electronic, or a combination of both. They can be used to secure the portable computer 106 in the automobile 102 to reduce the possibility that the portable computer 106 would be the target of thieves when the automobile 102 is left unattended. While it can be appreciated that the portable computer 106 can be removed from the coupling device 104 and taken away from the automobile 102, it may not always be practical or desirable to do so. To that end, the security devices (not shown) enable the portable computer to be folded into a closed position (to reduce visibility) and locked in place. In one arrangement of the present invention, the security device (not shown) used in conjunction with the coupling device 104 is configured such that if the portable computer 106 is removed from the coupling device 104 by an unauthorized person, the portable computer 106 will be rendered inoperative.

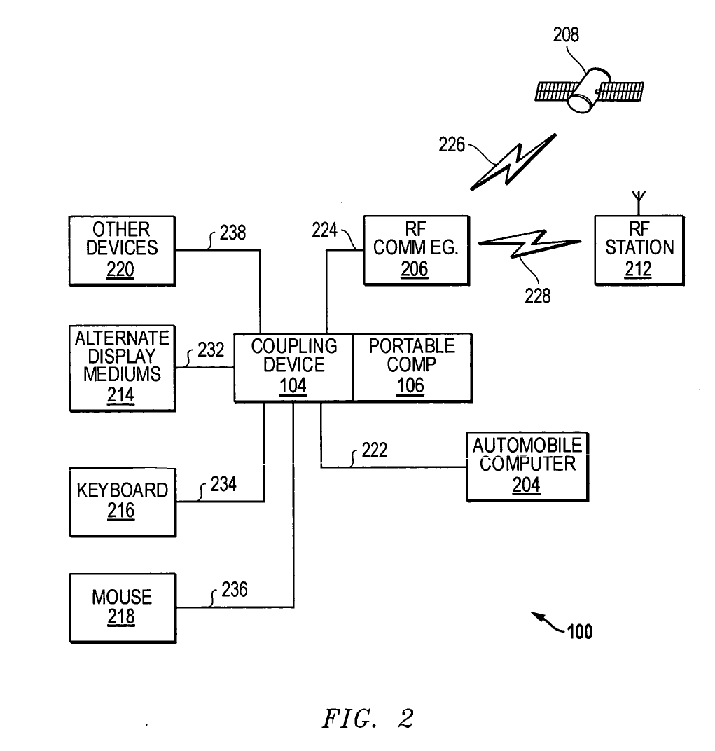

Referring to FIG. 2 of the drawings, the reference numeral 100 generally designates an integration system embodying a preferred embodiment of the present invention. The system 100 comprises a portable computer 106, a coupling device 104, and in this case, an automobile computer 204, a satellite 208, Radio Frequency (RF) communication equipment 206, an RF station 212, LCDs 214, a keyboard 216, a mouse 218, and other input mechanisms 220, such as game controllers or other devices.

When the system 100 is functioning, the portable computer 106 is coupled to the automobile 102 by means of the coupling device 104, as depicted in FIG. 1 or otherwise similarly coupled. When the portable computer 106 is in use within the automobile 102, there are multiple configurations in which the portable computer 106 can operate. If, for example, the coupling device 104 is mounted to the ceiling or roof of the automobile 102, then the display of the portable computer 106 can be folded down for usage. Software or hardware means can then be advantageously employed to invert the visual data on the screen of the portable computer 106, so that passengers within the automobile 102 can utilize the display of the portable computer 106. It can be appreciated that in arrangements of the system 100 in which the coupling device 104 is configured such that the display of the portable computer 106 is used in an upright position, such as when the coupling device 104 is in the console 110, there is not necessarily a need to invert the visual data.

Additionally, the coupling device 104 can be configured to output visual data to alternate display mediums 214, such as LCDs, within the automobile 102, either in place of the display on the portable computer 106, or simultaneously with output to the portable computer 106 display. Communication with the alternate display mediums 214 is accomplished by employing a communication channel 232 that allows the portable computer 106 docked in the coupling device 104 to transmit visual and/or audio data to the alternate display mediums 214.

In addition to being able to communicate to alternate display devices 214, the portable computer 106 can be configured to communicate with the automobile computer(s) 204 through the communication channel 222. A variety of pieces of data can be intercommunicated between the automobile computer 204 and the portable computer 106, such as telemetry data, vehicle information, or audio channel communications.

The portable computer 106 can be coupled to RF communication equipment 206 through communication channel 224 when mounted in the coupling device 104. There are various types of RF equipment and technologies that can be employed, such as cellular communication equipment, CDMA communication equipment, patch antennas, and so forth. In such cases, information can be intercommunicated from either a RF station 212, a satellite 208, or both through RF links 228 and 226, respectively. There are also a variety of services that can be provided through the RF links 228 and 226. For example, GPS data, webpage data, Voice over Internet Protocol (VoIP) data, and other network data can be provided. The computer networks for which the portable computer 106 can be connected include, but are not limited to, the Internet.

In addition to being able to have access to external devices and networks, the portable computer 106 is also capable of receiving data from other/multiple, or transmitting data to, devices contained within the automobile. Most notably, keyboards 216 and mice 218 can be used in conjunction with the portable computer 106. Each of the keyboards 216 and mice 218 can communicate with the portable computer 106 through communication channels 234 and 236, respectively, which can be wired or wireless channels. There are also a variety of other devices 220 that are capable of communicating with the portable computer 106 as well, such as scanners and external memory devices, which communicate with the portable computer 106 through communication channel 238.

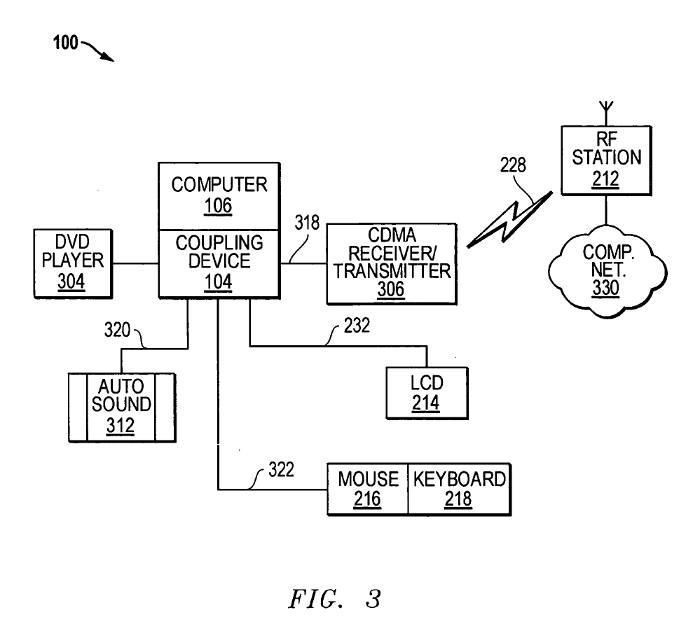

Now turning to FIG. 3 of the drawings, the reference numeral 100 generally designates an example integration system. The system 100 comprises a coupling device 104, a portable computer 106, a DVD player 304, a CDMA receiver/transmitter 306, LCD 214, automotive sound system 312, and mouse/keyboard 216, 218.

The portable computer 106 in this embodiment is coupled to the coupling device 104, as shown in FIG. 1. The portable computer 106 contains a DVD player 304, which is tied into the automobile 102 by means of the coupling device 104. It can be appreciated that the DVD player 304 could also be in the coupling device 104 as well as a stand-alone device integrated with the coupling device 104. The portable computer 106 can also be coupled to a remote LCD 214 which allows a DVD to be played, and the image projected on the remote LCD 214. Additionally, the portable computer 106 is tied into the sound system 312 of the automobile 102 via the coupling device 104 so that the audio from the DVD player 304 can be transmitted through the automobile sound system 312, rather than or in addition to the sound system on the portable computer 106, for an increased audio experience. In another arrangement of the device, the sound can be played through the portable computer 106 sound system, to which headphones (not shown) can be connected.

In addition to playing a DVD, the system 100 simultaneously or nearly simultaneously allows for wireless computer network access. The portable computer 106 is coupled to a CDMA receiver/transmitter 306 through the communication channel 318. The CDMA transmitter/receiver 306, then, can wireless communicate through the RF link 228 to the RF station 212. The RF station 212 allows for intercommunication with a computer network 330 that can include, but is not limited to, the Internet. The portable computer 106 can then display information on its own display, and/or the remote LCD 214, by transmitting information through the communication channel 232. A mouse/keyboard 216/218 can then allow a passenger to operate the portable computer 106 and browse the computer network 330. Additionally, the portable computer 106 can transmit audio information to an auxiliary audio device (not shown), such as a pair of headphones.

The increased applicability of the system 100 allows for a high degree of flexibility that was not previously provided in conventional systems. A user can easily transfer a portable computer 106 between an automobile, home, and office. Specifically, a user can employ the flexibility inherent in a portable computer 106 in an increased number of locations, allowing a user to both work and play at home, in the office, or on the road. In essence, a person need not be disconnected at any time with the increased flexibility. Moreover, the portable computer 106 can be added as part of an entertainment package or option during the sale of a vehicle. Specifically, the cost of the portable computer 106 can be included when a vehicle is purchased.

Additionally, the addition of a portable computer 106 can allow for easy updating and/or modifying vehicle computer information. In nearly all vehicles manufactured today, computer controls are integral to the operation of the engine, and depending on the desired performance, different performance curves can be uploaded to a vehicle computer. By having a portable computer 106 integrated into the vehicle, the performance characteristics of the vehicle can be modified by the user by allowing the portable computer 106 to wirelessly download the desired performance curves from the manufacturer. For example, if a vehicle is going to be towing, towing specific curves can be wirelessly downloaded.

It is understood that the present invention can take many forms and embodiments. Accordingly, several variations may be made in the foregoing without departing from the spirit or the scope of the invention. For example, there can be a variety of coupling and communication channels that can include both wireless and wireline communications (RS232, optical, coaxial, ethernet, and so forth).

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Accordingly, it is appropriate that the appended claims be construed broadly and in a manner consistent with the scope of the invention.

1. A system comprising:
an automobile having at least one auxiliary hardware module with at least one intended function and having a coupler adapted to communicate with said hardware module; and
a portable computer adapted to be removably secured to said coupler so as to provide processing and software to said hardware module to enable said hardware to perform said intended function, said portable computer being fully functional whether secured to the coupler or not.

2. The system of claim 1, wherein said at least one hardware module further comprises a satellite radio antenna and audio equipment.

3. The system of claim 2, wherein said portable computer processes a signal received by said satellite radio antenna and outputs audio data to said audio equipment.

4. The system of claim 1, wherein said at least one hardware module further comprises a Digital Versatile Disc (DVD) player and audio equipment.

5. The system of claim 4, wherein said portable computer processes a signal from said DVD player, outputs video, and outputs audio data to said audio equipment.

6. The system of claim 1, wherein said at least one hardware module is Radio Frequency (RF) equipment.

7. The system of claim 6, wherein said RF equipment is a Global Positioning System (GPS) antenna.

8. The system of claim 7, wherein said portable computer processes a signal from said GPS antenna and outputs indicia of GPS data.

9. The system of claim 6, wherein said RF equipment is selected from the group consisting of Wireless Fidelity (WiFi), cellular, and Code Division Multiple Access (CDMA) equipment.

10. The system of claim 9, wherein said portable computer provides wireless Internet Access.

11. An apparatus for coupling a portable computer to an automobile, comprising:
a mounting bracket for removably securing said portable computer; and
at least one communication channel adapted to interconnect the portable computer to at least one auxiliary hardware module with at least one intended function.

12. The apparatus of claim 11, wherein said at least one hardware module further comprises a satellite radio antenna and audio equipment.

13. The apparatus of claim 12, wherein said portable computer processes a signal received by said satellite radio antenna and outputs audio data to said audio equipment.

14. The apparatus of claim 11, wherein said at least one hardware module further comprises a DVD player and audio equipment.

15. The apparatus of claim 14, wherein said portable computer processes a signal from said DVD player, outputs video, and outputs audio data to said audio equipment.

16. The apparatus of claim 11, wherein said at least one hardware module is RF equipment.

17. The apparatus of claim 16, wherein said RF equipment is a GPS antenna.

18. The apparatus of claim 17, wherein said portable computer processes a signal from said GPS antenna and outputs indicia of GPS data.

19. The apparatus of claim 16, wherein said RF equipment is selected from the group consisting of WiFi, cellular, and CDMA equipment.

20. The apparatus of claim 19, wherein said portable computer provides wireless Internet Access.
